(19) United States
(12) Patent Application Publication
(10) Pub. No.: US 2014/0238533 A1
(43) Pub. Date: Aug. 28, 2014

(54) Efficiently effectively inserting inert gases into the entire volumes and ullage spaces of ships' steel ballast tanks to retard interior corrosion

(71) Applicants: Mo Husain, Encinitas, CA (US); Gary Shilling, Encinitas, CA (US)

(72) Inventors: Mo Husain, Encinitas, CA (US); Gary Shilling, Encinitas, CA (US)

(21) Appl. No.: 13/815,357

(22) Filed: Feb. 25, 2013

(51) Int. Cl. F17C 5/06

(52) U.S. Cl. CPC F17C 5/06
USPC 141/4

(57) ABSTRACT

A (1) piping grid, nozzles and/or deflectors and/or diffusers placed on the piping at a certain intervals, and (2) header pipes connecting the piping grid to (3) an inert gas generator via (4) a compressor and (5) an optional cooler support efficient and effective injection of inert gases into all regions and volume of ships' steel ballast tanks, retarding or avoiding corrosion. Efficiency in use of generated inert gas, effective entrance of inert gas into ballast tank spaces that may be remote and/or difficult of access, and minimization of the elapsed time to fill the tank with inert gas while discharging essentially all oxygen-containing air previously within the tank, are all realized by progressive, staged, insertion of cooled inert gases from tank bottom to tank top, marshaling contained air and expelling it out the tank tops.

### BACKGROUND OF THE INVENTION

1. Field of the Invention

The present invention generally concerns improvements to the apparatus, and to the method, wherein a mixture of inert gases is inserted into the steel ballast tanks of ships to retard interior corrosion of the tanks.

The present invention particularly concerns (1) progressively successively flowing inert gases (2) that are preferably cooled (3) through multiple orifices and diffusers (4) into the entire volume, or ullage space, of a steel ship's ballast tank that may be, and most often is, of irregular contour in order to (5) progressively intelligently force (warmer) atmospheric gases containing oxygen out sealable vents at the top of the tank so as to (6) retard corrosion in the interior of the ballast tank by (7) rendering inert the gases that are within all gas-exposed regions of the ballast tank without exception for regions that are remote and/or difficult to access.

2. Background of the Invention

2.1 Background to Ship's Ballast Tanks, and Their Corrosion Especially in New-Configuration “Double Hull” Tankers

Oceangoing tanker ships provide spaces for loading cargo and, separately, spaces for holding seawater ballast when not loaded. Typically, a tanker in ballast for vessels carrying petroleum liquids, the ullage space above the cargo in each tank must be filled with an inert gas to prevent fire. The ballast tanks nominally contain only seawater or are empty, and do not traditionally require inert gas. The ballast tanks corrode badly because of the seawater, and this type of damage is becoming a serious economic problem in some ships, especially tankers.

It has been found that an atmosphere of inert gas has a very significant anti-corrosion effect on steel surfaces subject to salt water. This protective effect is increasingly being exploited to protect the interior of ballast tanks. Conveniently, tanker vessels are already required to posses an onboard inert gas generator, and this gas mixture has been found to work well against corrosion. In its use in cargo tanks, this use of gas to replace air is called inerting.

Furthermore, additional inert gas may have to be introduced to an already inerted tank, to reduce the oxygen content further—occasionally needed to offset any ingress of atmospheric gases including oxygen through structural leaks—a process called purging.

Before taking on cargo, a tanker normally discharges the ballast used on the previous voyage and allows the empty ballast tanks to fill with air; the new anti-corrosion approach requires that the tank be filled with inert gas instead, and this gas is displaced when the ship again takes on cargo.

As tanks must be entered from time to time for inspection and repair, it must be entered by crew or workers. However, the inert gas, having very low oxygen and very high carbon dioxide, is dangerous to personnel and must be gas-free before the tank can be entered.

2.2 Prior Art Ballast Tank Inerting Systems

Previous patents dealing with the inerting of ship's tanks of all types include United Sates numbers:

U.S. Pat. No. 7,087,804 Use of waste nitrogen from air separation units for blanketing

RE 41,859 Infusion of combustion gases into ballast water preferably under less than atmospheric pressure to synergistically kill harmful aquatic nuisance species by simultaneous hypercapnia, hypoxia, and acidic ph level

U.S. Pat. No. 6,773,607 Ballast water treatment for exotic species control

U.S. Pat. No. 7,981,463 Hot-dip Sn-Zn coated sheet having excellent corrosion resistance

U.S. Pat. No. 6,702.263 Diffuser saddle connection

U.S. Pat. No. 6,372,140 Diffuser aeration method

U.S. Pat. No. 6,193,220 Diffuser aeration system

U.S. Pat. No. 7,964,067 Corrosion control of bottom plates in above-ground storage tanks

U.S. Pat. No. 6,773,607 Ballast water treatment for exotic species control

U.S. Pat. No. 6,761,123 Infusion of combustion gases into ballast water preferably under less than atmospheric pressure to synergistically kill harmful aquatic nuisance species by simultaneous hypercapnia, hypoxia, and acidic ph level

U.S. Pat. No. 5,335,615 Tanker vessel

U.S. Pat. No. 3,943.873 Cargo/ballast separation by due membrane

U.S. Pat. No. 8,002,249 Strip diffusers

U.S. Pat. No. 7,540,251 Apparatus and methods for treating ballast water by using electrolysis

U.S. Pat. No. 8,025,795 Ballast water treatment system

U.S. Pat. No. 7,875,130 Crude oil tank comprising a corrosion resistant steel alloy.

Previous published papers dealing with the inerting of ship's tanks of all types include:

1. Engineering Manuals EM 1110-2-3400, US Army Corp of Engineers, 30 Apr. 95

2. Corrosion and Cathodic Protection Theory by James B Bushman, P. E.

3. Final Report—Commercial Ship Design and Fabrication for Corrosion Control—SR-1377—By John Parente, John C. Daidola et al—M Rosenblatt & Son—1996

4. Ballast Tank Protection—Center for Tankship Excellence

5. Corrosion in double hull tankers by Dragos Rauta of Intertanko as appeared in TANKER Operator, May 2004

6. Abstract of Presentation at 28^{th} T.S.C.F. By Michael B. Kennedy Oct. 16, 2004

7. In Situ Study of the Parameters Quantifying the Corrosion in Ballast Tanks and an Evaluation of Improving Alternatives—Capt K. De Baere et al

8. Corrosion Protection Systems for Ballast Tanks and Void Spaces—Experts in Coatings & Corrosion—Amtec Consultants Ltd. December 2003

9. Industry searching for better ways to reduce ballast tank corrosion—Richard O. Aichele—Professional Mariner—2007

10. Life Cycle Cost of Venturi Oxygen Stripping System—Ballast Tank Corrosion Protection—NEI

11. Microbiological Influenced Corrosion: What it is and how it works Ronald J. Huggins P. E.

12. Guide for Inert Gas System for Ballast Tanks—American Bureau of Shipping—2004

13. The New Supertanker Plague—Richard Martin—The Wired Magazine—2002

14. Ballast water deoxygenation can prevent aquatic introductions while reducing ship corrosion. Biological Conservation. 103, 331-341. (2002) Tamburri, et al

15. How and why Corrosion Protection of Ballast Tanks Has Become the Business of Classification Societies—Eric Askheim, et al—Det Norske Veritas AS, Hovik, Norway

16. The Tankship Tromedy—The Impending Disasters in Tankers—Jack Devanney—2010

17. An Evaluation of Ballast Tank Corrosion in Hypoxic Sea Water—Jason S. Lee, Richard I Ray, Brenda J Little and Edward J. Lemieux. 2006 NACE International

The prior art in general teaches that it is known that ballast tank corrosion is reduced or effectively eliminated in oxygen-deprived, or “inerted”, atmospheres, and that it has been tried with varying success or lack thereof to inert the ullage gases of the ballast tanks of seagoing ships. See section 2.6, following.

2.3 Corrosion of Ships' Tanks Including Ballast Tanks

Corrosion of metal structures is practically unavoidable in the marine environment, especially in enclosed spaces having access to seawater. The extent of corrosion damage in ballast tank interior structures has increased significantly in recent times. OPA 90, which mandated double hulls for ocean-going tankers, required the addition of large enclosed volumes, most of which are adapted for ballast and are therefore often nearly filled with seawater and at other times with dead, humid air and petroleum-derived gases and vapors.

These spaces are difficult, sometimes very difficult, of access, and yet must be inspected and repaired, perhaps cleaned or coated by workers from time to time, thus requiring occasional safe human access. In addition, the desire to minimize structure in cargo spaces has required increased load-bearing structure in ballast spaces and voids. Even under moderate conditions, the ballast spaces provide a very hospitable environment for accelerated corrosion. Sometimes the deck can absorb solar heat, creating temperatures up to 140 degrees F. in interior spaces. For a new vessel, deterioration starts on the first day of operation and continues throughout its lifetime.

The economic consequences for ship operators are staggering. Corrosion-related hull repair and out-of-service costs are increasing. A related issue, which is yet to be fully explored, is the porous nature of the surface corrosion product, which may retain flammable or toxic gases to some degree even after cleaning.

Ballast tank corrosion has now perhaps become the principal reason for reduced service life in double hull tankers.

2.4 Coating and Cathodic Protection

For purposes of completeness, and in order that the utility of tank corrosion control via tank gas control in accordance with the present invention may be better appreciated, coating and cathodic protection is discussed in this section 2.4

Coatings have always been the primary defense against corrosion, although they have not always been required for ballast tanks in the past, and are not always very effective. There is nothing new in the use of coatings.

Ballast spaces represent about half of the ship's vulnerable area. In many cases they have small spaces that are hidden by structure and are essentially inaccessible, so complete coverage by applied coatings cannot be assured. Fluids, gases and microorganisms can reach anywhere. Despite these factors, ship operators are adopting a different approach: apply coatings, use anodic protection for the ballast leg of the voyage, and finally inert the empty tank during the cargo leg. These measures, as they are being applied in these new circumstances, are not very effective. A very apt view of the situation is provided by the Center for Tankship Excellence:
“There is no magic coating that will solve this problem. Using waterborne zinc silicate or a really well designed solvent free epoxy might be a substantial help, but unless the yards are forced to completely change their coating procedures,—a very good idea, by the way—will be forced to continue to use “application friendly” coatings which in longevity are little better than the coal tar epoxies of 25 years ago—and in some cases worse. No paint vendor will guarantee these coatings fore more than 10 years and these are bit of a joke . . . There have been numerous reports of double hull tankers less than five years old requiring massive coating repair. The best that an owner of a double hull VLCC relying on coating can hope for is to put off a 15 million dollar re-blast and recoat for ten or so years. The problem for the regulator is that most owners will put off this kind of expenditures for too long, which will generate a series of casualties, some of which may only involve spillage, but some of which will involve the loss of a crew.”

Cathodic protection uses attached zinc anodes to absorb electrolytic current flow that would otherwise cause oxidation. To quote again from the Center for Tankship Excellence,
“. . . But this has to be done properly and currently most tanker owner do a putrid job of maintaining cathodic protection in ballast tanks. The method of choice is a superintendent periodically inspects a tank, kicks the anode, and pontificates that the anode is or is it not still effective . . . somebody kick an anode and write down 30% wasted . . . .”

International regulations require the use of inert gas in cargo tanks, but not in ballast tanks, to prevent fire and explosion. However, empty ballast tanks are still vulnerable to the leakage of oil or gas from outside and the use of inert gas would have some fire protective value. As we will discuss below, however, the distribution of inert gas to all of the interior surface is not assured and thus the use of inert gas in the ballast tanks must provide for total distribution along the tank inner surface. This is the novelty of the invention, the combination of inert gas creation combined with its total distribution over all surfaces of the ballast tank interior

For purposes of completeness, and in order that the utility of tank corrosion control via tank gas control in accordance with the present invention may be better appreciated, coating and cathodic protection has been discussed in this section 2.4.

2.5 Corrosion Processes

Likewise for purposes of completeness, and in order that the utility of tank corrosion control via tank gas control in accordance with the present invention may be better appreciated, coating and cathodic protection is discussed in this section 2.5.

Types and sources of corrosion include electrochemical corrosion, galvanic corrosion, and Microbiologically Induced Corrosion (MIC).

Corrosion is primarily an electrochemical process; it is the deterioration of a metallic surface as a consequence of two chemical processes such as:

Anode reaction: 2Fe=>2Fe²⁺+4e

and

Cathode reaction: O₂+2H₂+4e⁻=>4OH⁻

These two reactions remove iron from one site and create iron oxide at a closely adjacent site. The resulting erosion creates pitting, providing additional area for further corrosion. The ionic forms constitute an electrical current. Zinc anodes provide protection by absorbing this current, which is an essential part of the corrosion process.

Galvanic corrosion occurs when two or more dissimilar metals are connected through a conductive environment such as salt water. Processes similar to those above deplete material from the anodic material and deposit it in some form on or around the cathodic material. Microbiologically Induced Corrosion (MIC) occurs when certain biological organisms cause a high rate of corrosion, affecting most alloys such as ductile iron, steel (including stainless) and copper. The numerous microorganisms that participate in these reactions are often characterized by their visible effects. Sludge-producing or sulfur-oxidizing life forms are involved in corrosion processes. Note in this connection that lack of oxygen does not prevent damage from these organisms. Typically, those of importance to us are either aerobic, requiring oxygen, or anaerobic, requiring no oxygen. Some sulfate-reducing bacteria, often well represented in harbor water, can create corrosion nodules and pits in a typical ballast tank environment.

2.6 The Mitigation or Avoidance of Corrosion Within Ships' Steel Ballast Tanks by Control of the Gases Within the Ballast Tanks

The present invention will be seen to concern improvements to an apparatus for, and to a method of, rendering substantially inert—and thus effectively incapable of supporting oxidation, or rust—the gases that are within the ullage spaces (including the substantial entire tank volume) of ship's ballast tanks. This “inerting” is in order to resist and retard corrosion (i.e., the oxidation of iron) within the interiors of these ballast tanks.

It has long been known that the corrosion of ferrous metals, or rust, requires oxygen. It has been contemplated that the “inerting”, or depletion of oxygen, of the gases within a ship's ballast tank would retard corrosion, or rusting, of the tank interior. See Tamburri et al [2002 Ballast water deoxygenation can prevent aquatic introductions while reducing ship corrosion. Biological Conservation. 103, 331-341.]

2.7 A Specific Instance of the Successful Control of Corrosion Within a Ship's Steel Ballast Tanks by Inerting of the Gases Within the Ballast Tanks

One ship, the Empress des Mer, was even temporarily equipped with such a ballast tank gaseous “inerting” system. The results privately reported by the then ship's owner David Devanney and his brother Jack Devanney were spectacular, with a substantially total avoidance of destructive corrosion to the interior of the tank.

However, this previous ballast tank inerting system suffered from, among other failings, (1) slowness, (2) difficulties in use and maintenance, and (3) high costs, requiring more “inert” (i.e., oxygen depleted) gas than was necessary to simply fill the volume of the ballast tank. This excess use of inert gas(es) was because, among other reasons and in hindsight, the exchange of gases within the tank from (1) oxygen-containing air to (2) a gaseous mixture depleted in oxygen was not optimal, with much mixing of (1) vented original air and (2) inserted replacement gases requiring excess replacement gases until the desired level of inerting was reached

Only method in existence appears to be that of Hellesponts Shipping method of inerting empty tanks. This method includes a pipe originating from a deck that ‘runs’ to the bottom of the tank and then extends horizontally up to the inner bulkhead—like a L shaped pipe. No matter how big is the tank, only a single pipe is used. It appears that American Bureau of Shipping (ABS) has adopted Hellespont's method in their analysis of inerting ballast tanks. Inert gas is available aboard tankers for fire safety reasons, and the inert gas generators are familiar to tanker-men. Today inert gas is used to inert the ullage space in cargo tanks, but it can also be used to inert ballast tanks if it can be made effective in preventing corrosion. Hellespont's Michael Kennedy and Jack Devanney of the Center for Tankship Excellence have described a method using a vertical insertion pipe at one end of a tank and an exhaust pipe at the other. The concern with this approach is that the inert gas must fully and effectively reach all points in the tank. HELLESPONT has created a finite-element computer model, VEN2TD, to evaluate and perfect means of distributing inert gas within the often-complex structure of a ballast tank. One of his findings was that gas-freeing required 2.5 times as long as inerting.

2.8 Corrosion of Ballast Tanks in “Double Hull Tankers” is a Severe Problem Circa 2012

Meanwhile, the “double hull tankers” mandated by the International Maritime Organization (“IMO”) are notorious for suffering from accelerated tank corrosion, drastically shortening the useful lives of tankers and supertankers that can cost hundreds of millions of dollars by up to ten years, and up to fifty percent (50%). Since the double hull tankers were desired and promoted by environmentalists, and were ultimately made mandatory by organizations presumptively outside the control of the maritime oil transport industry including gigantic oil companies, there has perhaps been some lassitude it attempting to prolong the operational lives of double tankers even if economically and cost-effectively done, and to instead simply pass along the increased cost of sea transport as part of the cost of oil.

Now, circa 2012, (1) market weakness to bear ever-higher costs for tanker-carried oil, if not (3) possible future energy sources competing with oil and/or (3) the possibility of a maritime catastrophe due to the corroded ballast tanks of ships, give reason to revisit corrosion control in and of ballast tanks in an attempt (1) to prolong the useable lifetimes and safety of ships in general and double-hulled tankers in particular, and (2) to reduce the cost of sea transport.

### SUMMARY OF THE INVENTION

The present invention contemplates improvements to the apparatus for, and to the method of, rendering substantially inert, and effectively incapable of supporting oxidation, the gases that are within the ullage spaces of ship's ballast tanks in order to resist and retard corrosion (i.e., the oxidation of iron) within the interiors of these ballast tanks.

Among other things, the invention contemplates that inert gases are entered into the ballast tank in respect of the complex geometry of the tank, making basically that the inert gases are entered into the tank from a multiplicity of locations all at the same time in an attempt to “coral” the existing air within the tank, and effectively guide it to ejection from vents at the top of the ballast tank. This “open volume gas substitution within ballast tanks of complex contours” is realized by a number of co-active, but essentially independent, strategies. These strategies are cooperatively employed so as to (1) uniformly inert the gases in all regions of the ballast tank so as to retard corrosion in all these regions while (2) wasting as little inert gas—which costs money to produce—in such inerting process.

First, an abundance of strategic-located inert gas diffusers and deflectors are used within ballast tanks of complex contours in order to insure that injected inert gases do early, effectively and efficiently penetrate into even the most distant reaches of the ballast tanks, providing corrosion protection thereto.

Second, the inert gases are preferably so entered at the preferred multiplicity of locations in stages through diffuser elements that cause that the inert gases enter the ballast tank not as a concentrated stream, but rather as what might be imagined (being that the actual gases are invisible) as an “cloud”, or a “wave” that tends to force the existing air within the tank upwards, and out. This “staged insertion of inert gases” can be—but need not invariably so be—exceedingly sophisticated in each of (1) space(s)/location(s), and (2) flow rate(s), and (3) times, of the insertion(s) of the inert gases. For example, a low flow of inert gas may be slowly made over a period of, most usually, some tens of minutes into both (1) low and (2) dead-ended regions of the ballast tanks, permitting natural gas diffusion to render these regional volumes at least partially inerted. Then the inert gas flow may be accelerated in volume and in flow rate through, most preferably, the overall lowest injection points within the entire ballast tank so as to “sweep” existing, atmospheric, ballast gases out the tops of the tanks.

Third, the present invention further contemplates that the injected inert gas mixtures—which are normally hot from having recently been produced by the combustion of fuel(s)—should be cooled—most preferably in a sea-water-cooled heat exchanger—before their injection into the bottom of ballast tanks. This cooling is so as to lower the temperature of the injected inert gases to as close as is practical to the temperature of (normally atmospheric) gases already within the ballast tanks, and preferably still lower than this temperature. Since warmer gases rise over colder gases, this helps insure that the bottom-injected inert gases—which cost money to produce—efficiently displace the gases including oxygen that are originally within the ballast tanks from out the vented tops of the tanks.

Fourth, the present invention still further contemplates that inert gas mixtures should be injected into the foul, dirty and wet interior environment of a ballast tank through a particular, “duck bill”, gas ejection fitting. This fitting helps prevent back flow of contaminants and/or ballast water from the ballast water tanks into the inert gas injection lines, which lines might otherwise become clogged.

In the most preferred practice of the invention one of more ballast tanks of exemplary configuration(s) are normally instrumented, and an intelligently-designed computer-controlled “purging” of the atmospheric tank gases in favor of inserted inert gases is performed, and monitored. Usually but only a small number of experiments will suffice to (1) eliminate all “hot spots” of un-purged gases (that are still supportive of corrosion) within the ballast tanks, (2) minimize the usage of inert gases, with total avoidance of overuse, so as to avoid wastage of inert gases, and (3) expedite the entire “purging” in time.

The present invention improves the exchange of a gaseous mixture depleted in oxygen, or “inerted” for the normal oxygen-containing air present in ships' steel ballast tanks for the purpose of retarding, or preventing, destructive interior corrosion of the ballast tank in at least four ways.

First, the inert gases are entered into the ballast tank in respect of the complex geometry of the tank, making basically that the inert gases are entered into the tank from a multiplicity of locations all at the same time in an attempt to “coral” the existing air within the tank, and effectively guide it to ejection from vents at the top of the ballast tank.

Second, the inert gases are so entered the preferred multiplicity of locations through diffuser elements that make that the inert gases enter the ballast tank not as a concentrated stream, but rather as what might be imagined (being that the actual gases are invisible) as an “cloud”, or a “wave” that trend to force the existing air within the tank upwards, and out.

Third, the inert gases—which are normally greatly hotter upon onboard production than is the air that is within the ballast tanks—are preferably cooled—most preferably in a heat exchanger with sea water—before entrance into the ballast tanks. These cooled inert gases are desirably, and normally, cooled so as to be no warmer than the ballast tank air and, when the sun cooperates by shining upon the ship and the tops of its ballast tanks, can even be some few degrees cooler than the air that is within the ballast tanks, The cooling of the inserted inert gaseous mixture is directed to addressing the thermo-dynamical truth commonly expressed as “warm air rises”, where colder (or at lest not warmer) inert gases inserted into the bottom of the ballast tanks to force the warmer contained air out the tops of these ballast tanks.

Fourth, the inert gas mixture is preferably inserted into the ballast tanks through a check valve, specifically a duckbill style check valve preferably made by Tideflex Technologies A Division Of Red Valve Company, Inc.—Carnegie, Pa., in accordance with many of the 36 patents of founder Spiros G. Raftis, and particularly U.S. Pat. No. 6,367,505 This particular style check valve is imminently suitable and effective for passing (inert) fluids and gases exclusively one-way into a contaminated environment, The ballast tanks—which of course contain remnant water—can be or become immensely filthy and contaminated with oil and dirt. The Tideflex valve is specifically sold for aeration, mixing and diffusion of one fluid (including gaseous fluids) into another, and is both durable and reliably operational in the foul environment inside the ballast tanks.

These and other aspects and attributes of the present invention will become increasingly clear upon reference to the following drawings and accompanying specification.

### BRIEF DESCRIPTION OF THE DRAWINGS

FIG. 1 is a top plan view showing an exemplary ship—and oil tanker—and (1) its cargo tanks, and also (2) its ballast tanks on which and in which is installed a preferred embodiment of the present invention.

FIG. 2 is a detail schematic diagram of the preferred embodiment of the system of the present invention previously seen in FIG. 1.

FIG. 3 is a first detail perspective view illustrating the plumbing and the diffusing of inert gas into the bottom and sides of an exemplary ship's ballast tank of the ship previously seen in FIG. 1 by the preferred embodiment of the system of the present invention previously seen in FIG. 2.

FIG. 4 is a detail perspective view of a preferred embodiment of an inert gas injector and diffuser nozzle—previously seen in FIG. 3—for inserting inert gases into, most typically, the bottom of a ship's ballast tank.

FIG. 5 is a second detail perspective view illustrating the plumbing and diffusing of inert gas into the bottom of an exemplary ship's ballast tank in the preferred embodiment of the system of the present invention previously seen in FIGS. 3 and 4.

FIG. 6 is a third detail perspective view illustrating the plumbing of inert gas into a side portion of an exemplary “cross-sectional L-shaped” ship's ballast tank in the preferred embodiment of the system of the present invention previously seen in FIGS. 3 and 4.

FIG. 7 is an enlarged detail isometric view of the gas ejection end of the preferred embodiment of an inert gas injector and diffuser previously seen in FIG. 4, this injector and diffuser being used in the preferred embodiment of the system of the present invention previously seen in FIGS. 3 and 4.

### DESCRIPTION OF THE PREFERRED EMBODIMENT

1. The Purposes of the System and Methods of the Present Invention

The improvements of the present invention are directed to effectively protecting the interiors of ships' ballast tanks—including in their voids and other closed spaces—from corrosion resulting from intermittent contact with fresh or salt water, or with other fluids that support electrolytic corrosion. As in the prior art, the system of the present invention delivers an inert gas mixture to the ullage spaces of ballast tanks in order to (1) protect the interiors of the steel ballast tanks from oxygen or other corrosion-supporting gases or vapors by removing or replacing them, while at other times (2) providing a means of clearing the ullage spaces of the ballast tanks of inert gas mixture in order to make these spaces acceptable for personnel access. Also as in the prior art, the system of the present invention preferably (3) protects the ballast tanks of oceangoing ships by using an inert mixture of combustion gases, including combustion gases as may be generated by the ship's own engines, and will be described in the context of that application.

Corrosion of saltwater tanks has always been a problem and is especially so in ships. Because of their frequent complexity and variable contents, ballast tanks have become vulnerable, especially in double-hull vessels, and require expensive periodic cleaning, resurfacing and repair. Use of an inert, gaseous mixture for mitigating or avoiding internal corrosion of the steel ballast tanks has been operationally proven to produce a satisfactory result, but problems have arisen. First, the shape and arrangement of the ballast tanks and their ullage spaces makes it difficult to assure contact of the protective inert gas mixture to all points within the tanks. Second, the filling of the tanks with inert gases has proven to be both time consuming, and wasteful of the inert gases which cost money to produce by burning fuel. Third, previous ballast tank inerting systems used simple apertured pipes that were often filled with ballast water—which is but seawater—and ballast tank debris when the inerting operation stopped, and thus became each of (1) susceptible to being plugged, and thus (2) unreliable to deliver inert gas at but modest pressures, and (3) themselves subject to interior corrosion.

Thus the previous apparatus, and methods, of inerting the ballast tanks of ships to reduce internal corrosion are desirous of improvement, and this the present invention seeks to do. The present invention contemplates to use and inert gas mixture obtainable from currently-available inert gas generators, providing an inert gas distribution system that guarantees access of the protective gas mixture to all points in a tank while also providing and effective method purging the tank of inert gas so as to “free” the space for human access. Nonetheless to the improvements of the system and method of the present invention, its installation and maintenance costs remain commensurate with prior art inerting systems, and quite moderate considering the extreme high cost of ship's overhaul, and early scraping, due to corrosion of the ballast tanks.

2. The Genesis of the System and Methods of the Present Invention

The assignee of the present invention—MH Systems, Inc. Of San Diego, Calif.—has already a patent protection for a ballast water treatment system using inert gas created on board and dispensed into loaded ballast tanks by bubblers located on or near the bottom. The present invention proposes a similar system to dispense the same type of inert gas into a similar distribution system. The distribution, however, must address the distribution of gas, not into liquid, into a significantly larger volume and more complex structures of ballast tanks.

The preferred method of the present invention uses a matrix or grid of nozzles connected to the ship's inert gas supply. The pressure required to drive these nozzles is of the same order of magnitude as that required to dispense inert gas into the cargo tanks in the fire protection system, and can be similarly, but not identically, controlled. It is expected that in a practical installation the positioning of the nozzles will be carefully planned so as to create an even dispersion. A computer analysis using the system described above or a similar one is needed. MH Systems has developed a mathematical model and simulated the proposed system and compared with the only existing system—the “existing system” appears to be the only one attempted inerting of an empty ballast tanks in an oil tanker vessel.

A typical installation could use nozzles spaced perhaps ten feet, disposed in a pattern favoring access to hidden locations. These nozzles would be similar to those used in, say, a waste water treatment plant, where aeration is needed and where there can be an accumulation of sludge just as there often is in ballast tanks. The nozzles could be directed downward to extend protection into a sludge layer.

Continuous and complete circulation of inert gas could be achieved in a few hours. The same process could be used to dispel the inert gas and replace it with air.

3. The Structure of the Preferred System of the Present Invention

The preferred system of the present invention is shown in FIGS. 1 through 7. In general the inerting of the gaseous contents of ballast tanks is realizes by (1) a piping grid, (2) nozzles and/or deflectors and/or diffusers placed on the piping at a certain intervals, and (3) header pipes connecting the piping grid to the inert gas generator via a compressor. The piping grids and the nozzle placement are shown in the drawings. The piping system is preferably either epoxy coated steel or PVC, except for the main header on the deck which is most preferably epoxy coated steel. The nozzles selected for this application of ballast tank of double hull tankers are actually diffusers, similar to Tideflex model TFAHP. This type of nozzles/diffusers have an alternate use—that is to diffuse gas into a liquid , i.e into ballast water.

3.1 The Plumbing of an Entire Ship to Deliver Inert Gases into the Ballast Tanks of the Ship

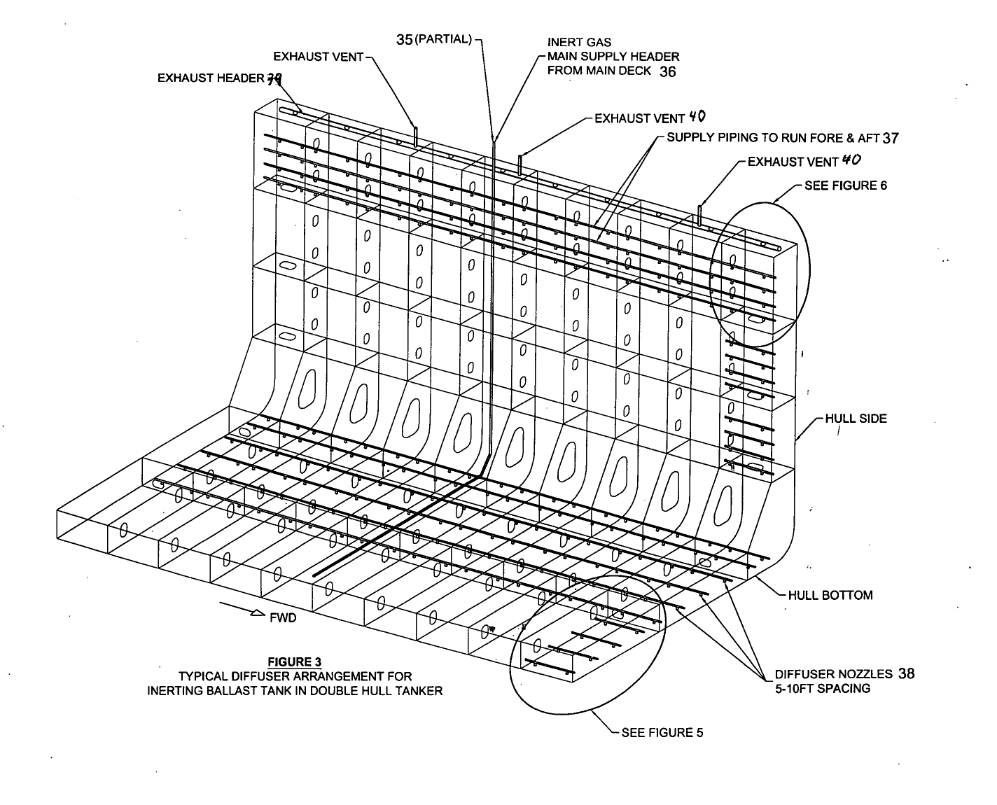

A plan view of a ship and its tanks on which and in which is installed a preferred embodiment of system of the present invention is shown in FIG. 1. The illustrated ship 1 is, by way of example, an oil tanker. This type of ship in particular has significant problems with corrosion in ballast tanks which are “L-shaped” in cross section (for a “double-hulled” tanker), as will later best be seen in FIG. 3.

The ship 1 includes both CARGO tanks 11 and BALLAST tanks 12, each illustrated to be 12 in number. Still further additional tanks of both types may be present.

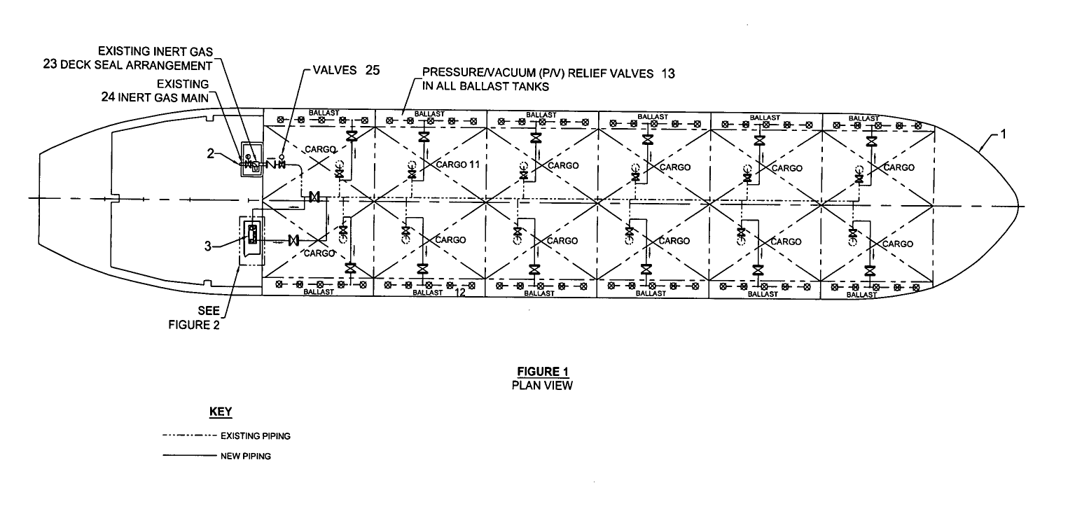

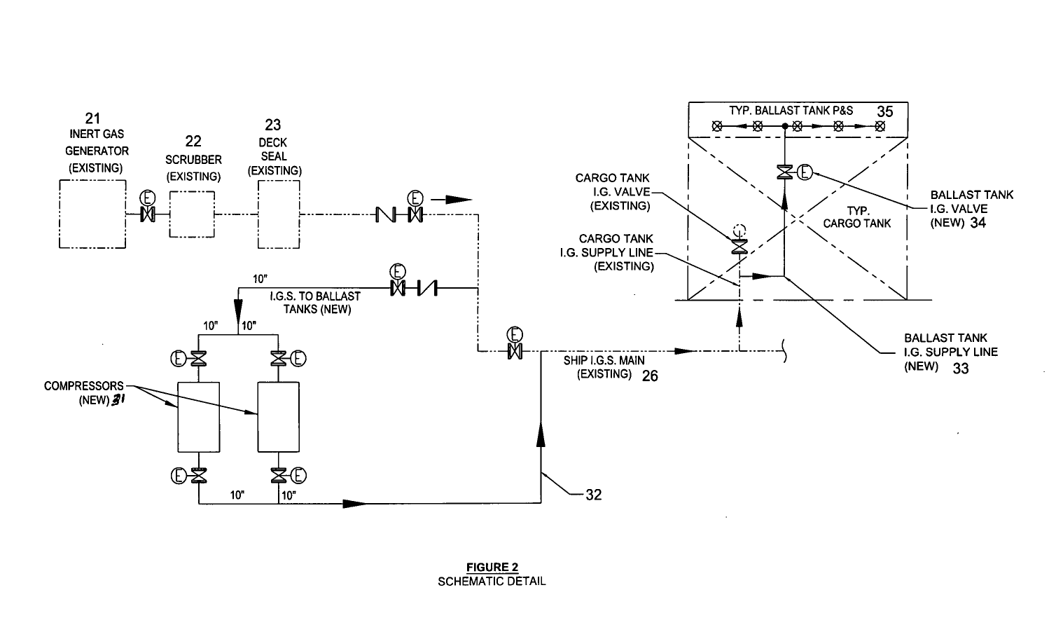

In accordance with MARPOL requirements the ship 1 in the form of an oil tanker, or Very Large Crude Carrier, or VLCC, has its CARGO tanks 11 (which contain the transported oil) inerted and pressurized in their ullage spaces by an inerting system. The inerting system 2 includes an existing inert gas generator 21 and scrubber 22 (seen in FIG. 2) connected via an EXISTING INERT GAS DECK SEAL ARRANGEMENT 23 to an EXISTING INERT GAS MAIN 24 for distribution via VALVES 25 to the CARGO TANKS 11.

To this existing ships CARGO tank inerting system the present invention adds a system 3 for the inerting of the BALLAST tanks 12. Additional equipments of this “add-on” system 3 are in part typically located on the deck of the ship 1 in that location labeled “SEE FIG. 2” within FIG. 1.

Referring now to said FIG. 2, the existing ships cargo tank inerting system 2 will now be observed to be augmented, and extended, by certain new (1) equipments and (2) plumbing concerned with the ballast tank inerting system 3 of the present invention. The added equipments of this ballast tank inerting system 3 that are mounted to the deck of ship 1 preferably includes one of more COMPRESSORS (NEW) 31 that tap the output of the existing INERT GAS GENERATOR (EXISTING) 21, via existing SCRUBBER (EXISTING) 22 and existing DECK SEAL (EXISTING) 23. The COMPRESSORS (NEW) 31 compress the inert gas before sending it via added new plumbing 32, via existing plumbing SHIP I.G.S. MAIN (EXISTING) 26, and still further via still further via added new plumbing in the form of BALLAST TANK I. G. SUPPLY LINE (NEW) 33, BALLAST TANK I.G. TANK VALVE (NEW) 34 and TYP.[ical] BALLAST TANK P & S 35. Inert Gas (“I.G.”) is thus newly rounted to the ballast tanks 12.

Note that there are existing CARGO TANK I.G. VALVE (EXISTING) and CARGO TANK I.G. SUPPLY LINE (EXISTING) for supply inert gas to the cargo tanks 11. These valves and supply lines are associated with the existing ship's system for rendering inert the ullage spaces of oil cargo tanks as required by MARPOL regulations, and such as is well known in the art.

The nature of this new plumbing including both lines and valves, and still further new elements including injector/diffuser nozzles, is made increasingly clear by reference to FIG. 3. An INERT GAS HEADER SUPPLY FROM MAIN DECK line 36 begins the BALLAST TANK P & S 35 previously seen in FIG. 2. From this central supply line 36 running downwards into a BALLAST TANK 12 (previously seen in FIG. 1) SUPPLY PIPING TO RUN FORE AND AFT 37 extends. Periodically along this piping 37 are positioned DIFFUSER NOZZLEs 38, typically and 5-10 FT SPACING. Such inert gas as is entered into the BALLAST tank 12 ca be evacuated through EXHAUST HEADERs 39 and EXHAUST VENTs 40.

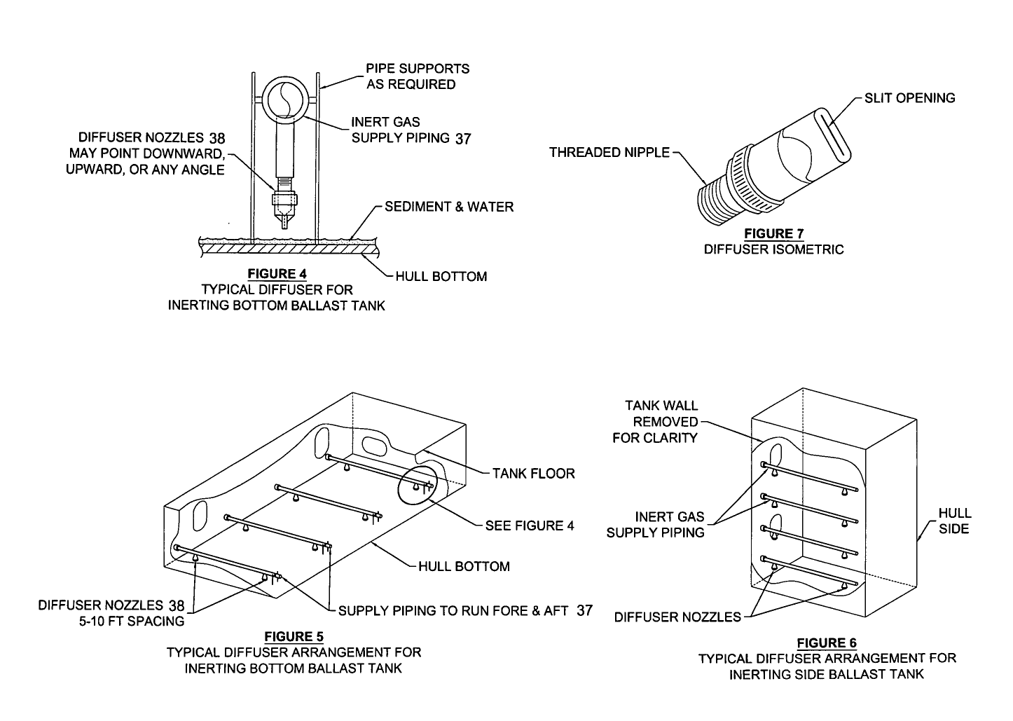

A detail perspective view of an exemplary inert gas injector and diffuser nozzle, or DIFFUSER NOZZLEs 38—previously seen in FIG. 3—is shown in detail in FIG. 4. A DIFFUSER NOZZLE 38 acts to turbulently inserting inert gas into the ship's BALLAST tank 12, most typically starting at the bottom. A DIFFUSER NOZZLE 38 that is low in the BALLAST tank 12 might thus be above the HULL BOTTOM and SEDIMENT AND WATER, where the DIFFUSER NOZZLE MAY POINT DOWNWARD UPWARD OR AT ANY ANGLE, where there are PIPE SUPPORTS AS REQUIRED for, and to, the INERT GAS SUPPLY PIPING (e.g., the SUPPLY PIPING TO RUN FORE AND AFT 37 previously seen in FIG. 3).

A second detail perspective view illustrating the plumbing and diffusing of inert gas into the bottom of an exemplary ship's ballast tank in the preferred embodiment of the system of the present invention (previously seen in FIGS. 1 and 2) is shown in FIG. 5. A TYPICAL DIFFUSER ARRANGEMENT FOR INERTING BALLAST TANK is illustrated. Clearly the DIFFUSER NOZZLEs 38 are periodically spaced along the INERT GAS SUPPLY PIPING, also called SUPPLY PIPING TO RUN FORE AND AFT 37 previously seen in FIG. 3).

Yet a third detail perspective view illustrating the plumbing of inert gas into a side portion of an exemplary “cross-sectional L-shaped” ship's BALLAST tank 12 in the preferred embodiment of the system of the present invention is shown in FIG. 6. Particularly illustrated is an exemplary placement of the DIFFUSER NOZZLEs 38 periodically along the INERT GAS SUPPLY PIPING, also called SUPPLY PIPING TO RUN FORE AND AFT 37, at the sides of the BALLAST tank 12.

A detail isometric view of a preferred inert gas injector and DIFFUSER NOZZLE 38 in the preferred embodiment of the system 3 of the present invention—previously seen in FIGS. 1 through 6—is shown in FIG. 7. The preferred DIFFUSER NOZZLE 38 has a THREADED NIPPLE and a duckbill SLIT OPENING. This duckbill SLIT OPENING opens to admit inert gas into the BALLAST tank 12 including under water—both above and under water nozzle positions may be heavily contaminated—without permitting significant back flow of contaminants into SUPPLY PIPING TO RUN FORE AND AFT 37 (previously seen in FIGS. 3-6).

4. The Preferred Method of Using the Preferred System of the Present Invention

The preferred use of the preferred ballast tank inerting system of the present invention involves any and all of (1) injecting and diffusing flowing inert gas into spaces that may be remote and/or difficult of access to ensure complete coverage, (2) progressive, staged, insertion of inert gases from tank bottom to tank top to best assure maximum expunging of atmospheric gases including oxygen with minimum volumes of (costly) inert gases, including by (3) injecting inert gases that are cooled below the temperature of ballast tank gases starting from the bottoms of the ballast tanks.

4.1 Injecting and Diffusing Flowing Inert Gas

Inert gas conventionally derived by the standard inert gas system of a ship 1 in the form of an oil tanker is entered via computer control valves into a system 3 for progressively delivering this inert gas to the ship's BALLAST tanks 12.

4.2 Progressive, Staged, Insertion of Inert Gases

Delivery is progressive, and staged, so that lower regions of the BALLAST tanks 12 are first completely inerted while exiting, atmospheric, gases are force out the tops of the BALLAST tanks 12 until the BALLAST tank 12 is substantially completely filled with inert gas.

4.3 Control of the Temperature of the Inert Gas Flow

(1) Efficiency in use of inert gas, and (2) minimization of the elapsed time to fill the tank with inert gas while discharging gas or air within the tank, are effected by making use of the relative densities of gases according to temperature, where higher temperature gas is less dense than lower temperature gas.

In accordance with the present invention the inert gas is (1) generally mostly introduced at the bottom of the ballast tanks (2) at a some, or, more preferably, lower temperature than the is ambient gas within the ballast tank. When the inert gas is introduced, it will sink, displacing and pushing higher the ambient gas that is of the same or higher temperature, and thus lower density.

During this introduction of inert gas further diffusers are preferably located higher in the tank than are the points if inert gas introduction, and of lower “inert gas outlet” diffusers, in order to mor substantially maximize the mixing of gases. The sinking pressure created by the sinking of the more dense gas will force the ambient gas upwards to be discharged from the tank vent.

Conversely, if the gas being introduced were to undesirably be of a higher temperature than was the ambient gas within the ballast tanks, when this inert gas was introduced it would rise, pushing higher than the ambient gas for being of higher temperature. In this case, inert gas diffusers lower in the tank would be used rather than the higher diffusers in order to minimize the loss of invert gas through the tank vents.

Inert gas diffusers ganged together on the same inert gas supply line are all preferably placed in a level horizontal plane at approximately the same height within each ballast tank. Each level of diffusers is normally supplied with a separate supply line. Further, each supply line for each horizontal plane of diffusers is connected to the primary inert gas supply located on top a deck of the ship, and inert gas flow though each line is preferably gated by computer-controlled valves. Sensors are preferably located at three or more levels inside each tank to measure gas densities and temperature. Sensors are placed in the output of the inert gas booster pump to measure the density and temperature of the inert gas produced by the inert gas generator.

A computer system controls the inert gas feed valves at each different level within the tank according to (1) the relative gas density and temperature differences between the inert gas being introduced into a tank and the ambient gas or air currently in the tank, (2) the rate of inert gas flow relative to tank capacity (at each successive level), and (3) a time sequence by which the lower regions of the tank are progressively first inerted, pushing the ambient gas (normally atmospheric gases including oxygen) that were previously within the tank upwards and out through openable-and-closeable vents that the top of the tank.

As the composition of the gas changes within the tank, the control system adjusts the flow at the different horizontal levels to minimize the amount of gas that has to be introduced in order to achieve the gas densities desired and to minimize the amount of time required to achieve the target inert gas densities.

Notably, the present invention further contemplates maintaining (with force of COMPRESSORS (NEW) 31 shown in FIG. 2) a gas pressure in the ballast tanks 12 that is slightly greater than atmosphere, and is more preferably from 0.5 p.s.i. to 1.0 p.s.i. greater than atmosphere. This serves to “top up” the ballast tanks with inert gas during the course of the voyage in order to substantially avoid an ingress of atmospheric gases including oxygen into the ballast tanks 12 during the course of the ship's voyages, thus maintaining optimally anti-corrosive conditions.

According to these variations, and still others within the skill of a practitioner of the marine ships' engineering and gas flow arts, the present invention should be considered in accordance with the following claims, only, and not solely on accordance with those embodiments within which the invention has been taught.

What is claimed is:

1. A method of retarding such corrosion as would normally occur in air of the interior of a ship's steel ballast tank of complex geometry, the method comprising:
entering a mixture of gases depleted in oxygen into the ship's ballast tank from a multiplicity of gas emission points at a corresponding multiplicity of locations selected in respect of the complex geometry of the tank so as to, insofar as is possible, “coral” existing atmospheric air within the tank, and force this air from the bottom and from the farthest lateral regions of the tank onwards and upwards to ejection from vents at the top of the ballast tank;
wherein by strategic selection of the multiplicity of locations less of the gaseous mixture is used to develop an inerted condition inside the tank than would be the case if the gaseous mixture was simply pumped into the tank at one or at two tank bottom locations;
wherein by strategic selection of the multiplicity of locations less of the gaseous mixture is used to faster develop an inerted condition inside the tank than would be the case if the gaseous mixture was simply pumped into the tank at one or at two tank bottom locations;
wherein by strategic selection of the multiplicity of locations less of the gaseous mixture there are a reduced number, or no, isolated regional volumes within the tank that still contain air as would be the case if the gaseous mixture was simply pumped into the tank at one or at two tank bottom locations;
wherein the gaseous mixture entered into the ballast tank retards such corrosion as would normally occur in air throughout the entire interior of the tank without significant omitted volumes or “hot spots” nonetheless that this gaseous mixture is judiciously entered in minimal effective quantity;
wherein the entering provides (1) better coverage of the tank interior volume with (2) less wastage of gaseous mixture out the vents than would alternatively be the case if the gaseous mixture was simply pumped into the tank at one or at two tank bottom locations.

2. The method of retarding such corrosion in the interior of a ship's steel ballast tank according to claim 1 further comprising:
maintaining insofar as possible during voyages of the ship the gaseous mixture entered into the tank to be at a positive pressure greater than atmosphere;
therein to preclude leakage of atmospheric gases including oxygen into the ballast tanks during voyages of the ship;
therein to, insofar as proves possible under ship's operating conditions, prolong the preservation of the anti-corrosive mixture of gases within the ship's ballast tanks.

3. A method of retarding such corrosion as would normally occur in air of the interior of a ship's steel ballast tank of complex geometry, the method comprising:
entering a mixture of gases depleted in oxygen into the ship's ballast tank from a multiplicity of gas diffuser elements at a corresponding multiplicity of locations selected in respect of the complex geometry of the tank so as to, insofar as is possible, form from the entered gaseous mixture a “cloud”, or a “wave, that trends to force the existing air within the tank onwards and upwards to ejection from vents at the top of the ballast tank;
wherein the movement of gases is demonstrable by Computational Fluid Dynamics to be, for said tank of complex geometry, more, and better, than simply putting a gaseous mixture in at a one tank end and taking out displaced gases at an opposite tank end, but truly is, in respect of the design and function of both said diffuser elements and the multiplicity of locations at which they are placed, a (1) faster and (2) more efficient way to exchange gases within the tank then would be the case if the gaseous mixture was simply pumped into the tank at one or at two tank bottom locations while air within the tank was ejected from the top vents.

4. The method of retarding such corrosion in the interior of a ship's steel ballast tank according to claim 3 further comprising:
maintaining insofar as possible during voyages of the ship the gaseous mixture entered into the ballast tank to be at a positive pressure greater than atmosphere;
therein to preclude leakage of atmospheric gases including oxygen into the ballast tank during voyages of the ship;
therein to, insofar as proves possible under ship's operating conditions, prolong the preservation of the anti-corrosive mixture of gases within the ship's ballast tanks.

5. A method of retarding such corrosion as would normally occur in air of the interior of a ship's steel ballast tank of complex geometry, the method comprising:
cooling a mixture of inert gases to below the temperature of air that is within a ship's ballast tank of complex geometry; and
entering the mixture of inert gases into the ship's ballast tank from a multiplicity of gas emission points including at the bottom of the tank so that this entered mixture will tend to settle beneath the warmer air of the tank, and to progressively force this air onwards and upwards to ejection from vents at the top of the ballast tank.

6. The method of retarding such corrosion in the interior of a ship's steel ballast tank according to claim 5 further comprising:
maintaining insofar as possible during voyages of the ship the gaseous mixture entered into the ballast tank to be at a positive pressure greater than atmosphere;
therein to preclude leakage of atmospheric gases including oxygen into the ballast tank during voyages of the ship;
therein to, insofar as proves possible under ship's operating conditions, prolong the preservation of the anti-corrosive mixture of gases within the ship's ballast tanks.

7. A method of retarding such corrosion as would normally occur in air of the interior of a ship's steel ballast tank of complex geometry, the method comprising:
entering a mixture of gases depleted in oxygen into the ship's ballast tank through a multiplicity of duckbill style check valves at a corresponding multiplicity of locations selected in respect of the complex geometry of the tank so as to, insofar as is possible, “coral” existing atmospheric air within the tank, and force this air from the bottom and from the farthest lateral regions of the tank onwards and upwards to ejection from vents at the top of the ballast tank.

8. The method of claim 7
wherein the duckbill style check valve is made by Tideflex Technologies, a Division Of Red Valve Company, Inc., Carnegie, PA, in accordance with at least one patent of company founder Spiros G. Raftis issued before Feb. 1, 2013.

9. The method of claim 7
wherein the duckbill style check valve is made in accordance with U.S. Pat. No. 6,367,505, and is both durable and reliably operational in a foul environment inside the ballast tank.
